(19) United States
(12) Patent Application Publication
(10) Pub. No.: US 2009/0107609 A1
(43) Pub. Date: Apr. 30, 2009

(54) High Extensible Cut-Resistant Barrier

(76) Inventors: Walter Kevin Westgate, Uniontown, OH (US); Judith Anne Tweedie, Uniontown, OH (US); John Fleming Brainerd, II, Medina, OH (US)

Correspondence Address: BROUSE MCDOWELL LPA, 388 SOUTH MAIN STREET, SUITE 500, AKRON, OH, 44311, US

(21) Appl. No.: 11/931,973

(22) Filed: Oct. 31, 2007

(51) Int. Cl. B60C 9/00; B32B 27/34

(52) U.S. Cl. 152/548; 428/221

(57) ABSTRACT

A tire including a carcass, a crown portion, shoulders, sidewalls, a bead region, two beads, the beads being within the bead region, and at least one cord, the cord being at least two of the group comprising aramid fibers, polyamide fibers, liquid crystalline aromatic polyesters, carbon fibers, fiberglass, and metallic fibers, is herein described.

### I. BACKGROUND OF THE INVENTION

A. Field of Invention

This invention pertains to the art of methods and apparatuses regarding tire construction, and more particularly to methods and apparatuses regarding high extensible cut-resistant barriers for tires.

B. Description of the Related Art

It is known in the art to try to provide tires with resistance to damage by road debris. This can be accomplished in many different ways.

Current tire sidewall reinforcement configurations provide a low level of cut resistance for tires. A need has evolved to significantly improve the cut resistance of tires, as well as provide overall climbing ability while minimizing any appreciable structural damage.

### II. SUMMARY OF THE INVENTION

According to one embodiment of this invention, a unidirectional fabric for use in an associated vehicle tire includes an aramid/polyamide 6,6 merge cord, wherein the fabric is at an angle to a ply angle in the associated tire.

According to another embodiment of this invention, a tire includes a carcass, a crown portion, shoulders, sidewalls, a bead region, two beads, the beads being within the bead region, and at least one cord, the cord being at least two of the group comprising aramid fibers, polyamide fibers, liquid crystalline aromatic polyesters, carbon fibers, fiberglass, and metallic fibers.

According to another embodiment of this invention, the cord is chosen from the group comprising a merge cord, a hybrid, and a core insertion.

According to another embodiment of this invention, the cord is chosen from the group comprising unidirectional, bidirectional, multidirectional, film, weave, and knit.

According to another embodiment of this invention, the cord is a merge cord.

According to another embodiment of this invention, the cord is aramid fibers and polyamide fibers.

According to another embodiment of this invention, the cord is a core insertion.

According to another embodiment of this invention, the cord has a cord density of approximately 5 to approximately 40 epi, approximately zero to 10 twist multiplier, and a cord mass of approximately 440 dtex to approximately 10,000 dtex.

According to another embodiment of this invention, the cord is at an angle with respect to a ply angle, wherein the cord is at an angle of between approximately 135° and approximately 45°.

According to another embodiment of this invention, the tire is chosen from the group comprising bias, radial, OTR (off the road), aircraft, racing, farm, ATV (all terrain vehicle), MT (medium truck), LT (light truck), and passenger.

According to another embodiment of this invention, the cord is at an angle with respect to a ply angle, wherein the cord is at an angle of between approximately 55° and approximately 45°.

According to another embodiment of this invention, a tire includes a carcass, a crown portion, shoulders, sidewalls, a bead region, two beads, the beads being within the bead region, and at least one cord, the cord comprising aramid fibers and polyamide fibers, wherein the cord is chosen from the group comprising a merge cord, a hybrid, and a core insertion, wherein the cord is at an angle with respect to a ply angle, wherein the cord is at an angle of between approximately 135° and approximately 45°.

One advantage of this invention is improved sidewall cut resistance for tires.

Another advantage of this invention is improved overall climbing ability while minimizing any appreciable structural damage.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a cutaway view of a tire;

FIG. 2 is a graph showing the improvement in sidewall impact of the present invention;

FIG. 3 is a another graph showing height at which puncture occurred at 35 psi (pounds per square inch);

FIG. 4 is another graph showing height at which puncture occurred at 15 psi;

FIG. 5 is another graph showing average puncture height at 35 psi and 15 psi;

FIG. 6 is a perspective view of a merge cord; and,

FIG. 7 is a perspective view of a core insertion.

### IV. DEFINITIONS

The following terms may be used throughout the descriptions presented herein and should generally be given the following meaning unless contradicted or elaborated upon by other descriptions set forth herein.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt” refers to a band formed at least in part from one or more flexible materials.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Carcass” means the tire structure apart from the belt structure, tread, undertread, and sidewall rubber over the plies, but including the beads.

“Cord” means one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“dtex” means decitex, which is 1 gram per 10,000 meters.

“EPI” means ends per inch.

“Equatorial plane (EP)” means the plane perpendicular to the tire's axis of rotation and passing through the center of its tread.

“Fabric” means a network of extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Floater” is defined as a ply component that is not wrapped around the bead.

“Merge” refers to a physical combination of two or more dissimilar fiber bundles.

“Ply” means a continuous layer of rubber-coated parallel cords in the context of a tire and also means a twisted yarn in a context of a yarn or a cord as used herein the meaning is dependant on the context.

“Radial” and “radially” are used to mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Sidewall” means that portion of a tire between the tread and the bead.

“Tread” means a molded rubber component which, when bonded to a tire casing, includes that portion of the tire that comes into contact with the road when the tire is normally inflated and under normal load.

“Twisted” means the number of turns about its axis per unit of length of a yarn, turns per inch being TPI.

“Twist multiplier” is a unit which helps to decide the twist per unit length for different counts from the same material. This is the angle of inclination of the helical disposition of the fiber in the material.

“Yarn” occurs in the following forms: 1) a number of fibers twisted together; 2) a number of filaments laid together without twist; 3) a number of filaments laid together with a degree of twist: 4) a single filament with or without twist (monofilament); 5) a narrow strip of material with or without twist.

### V. DETAILED DESCRIPTION OF THE INVENTION

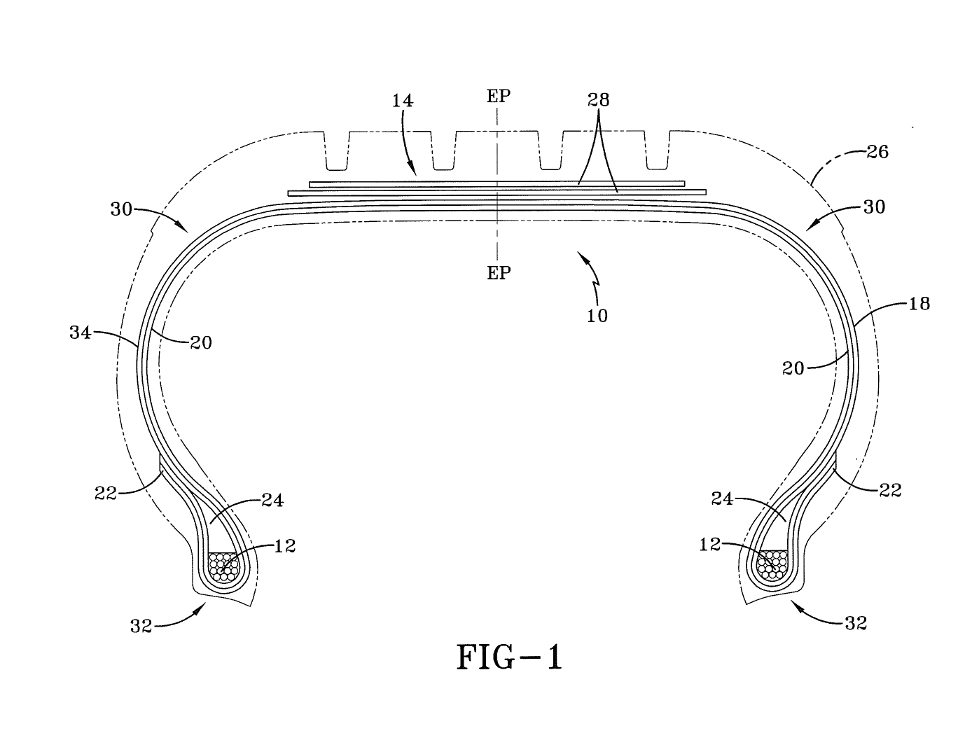

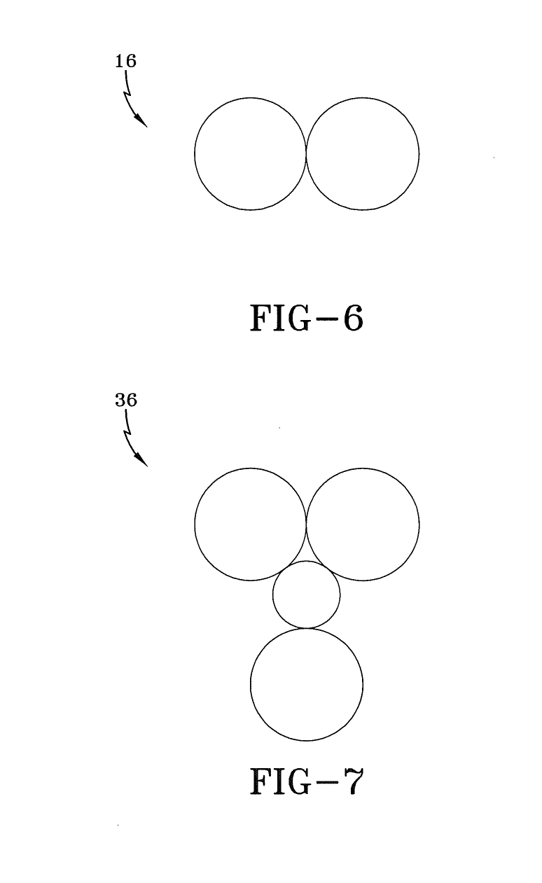

Referring now to the drawings wherein the showings are for purposes of illustrating embodiments of the invention only and not for purposes of limiting the same, FIG. 1 shows a tire with a carcass 10, beads 12, crown 14, first ply 20, right second ply 18, left second ply 34, shoulders 30, bead region 32, turn-up ends 22, bead core 24, and belts 28. FIGS. 6 and 7 show a merge cord 16 and a core insertion 36.

With continuing reference to FIGS. 1, 6, and 7 the present invention incorporates a fabric cord as a load bearing, or non-load bearing, ply, which may or may not replace an existing ply. In one embodiment, the cord is a aramid/polyamide 6, 6 merge cord 16. The merge cord 16 can also be referred to as a hybrid cord, wherein every other lobe is a different material. Therefore, in one embodiment of the invention, the merge cord 16 alternates aramid and polyamide 6, 6. In one embodiment of the invention, the cord 16 is between a 45° and a 55° angle to the ply angle. In one embodiment of this invention, the cord 16 is a unidirectional fabric. In another embodiment, the cord is between a 45° and a 135° angle to the ply angle. It is to be understood, however, that the angle can be between approximately 0° and approximately 180°.

Still referring to FIGS. 1, 6, and 7, the present invention can also be a core insertion 36, as shown in FIG. 7. In this embodiment, the center of the core insertion 36 is a different material than the outer portion. In one embodiment of the invention, the core insertion 36 is between a 45° and a 55° angle to the ply angle. In one embodiment of this invention, the core insertion 36 is a unidirectional fabric. In another embodiment, the cord is between a 45° and a 135° angle to the ply angle. It is to be understood, however, that the angle can be between approximately 0° and approximately 180°. Although in the preceding two paragraphs, the invention has been described as unidirectional, it is to be understood that any of the following configurations would also work: bidirectional, multidirectional, weave, film, and knit. In another embodiment, the present invention can be a hybrid, which is similar to the core insertion 36 shown in FIG. 7, except that the hybrid has spaces between the fibers.

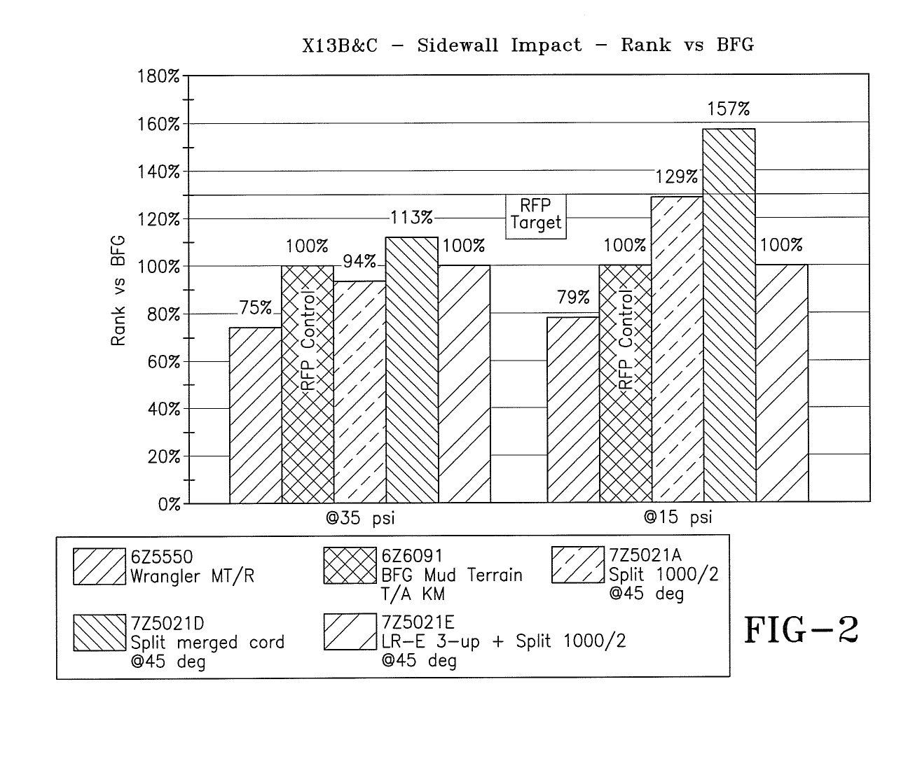

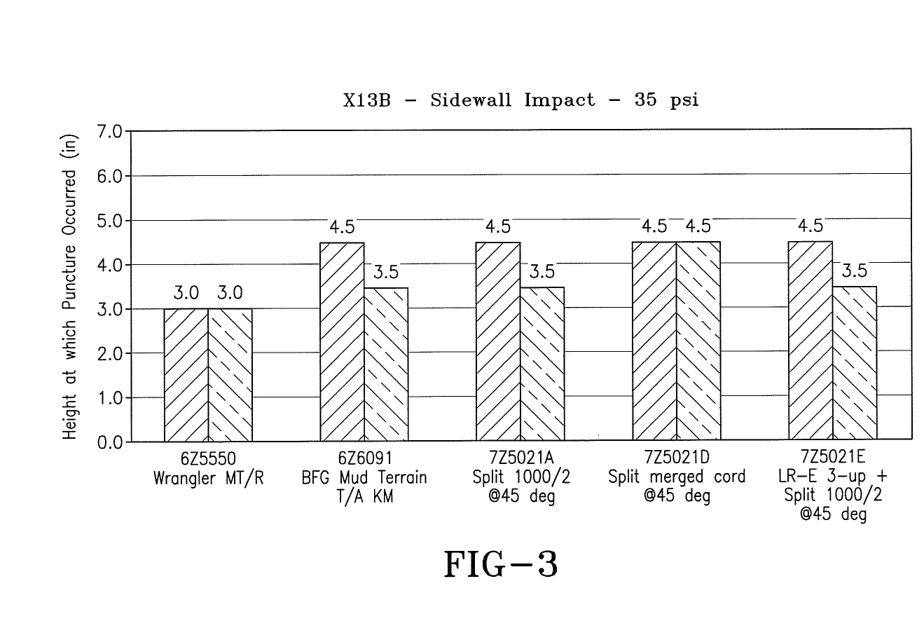

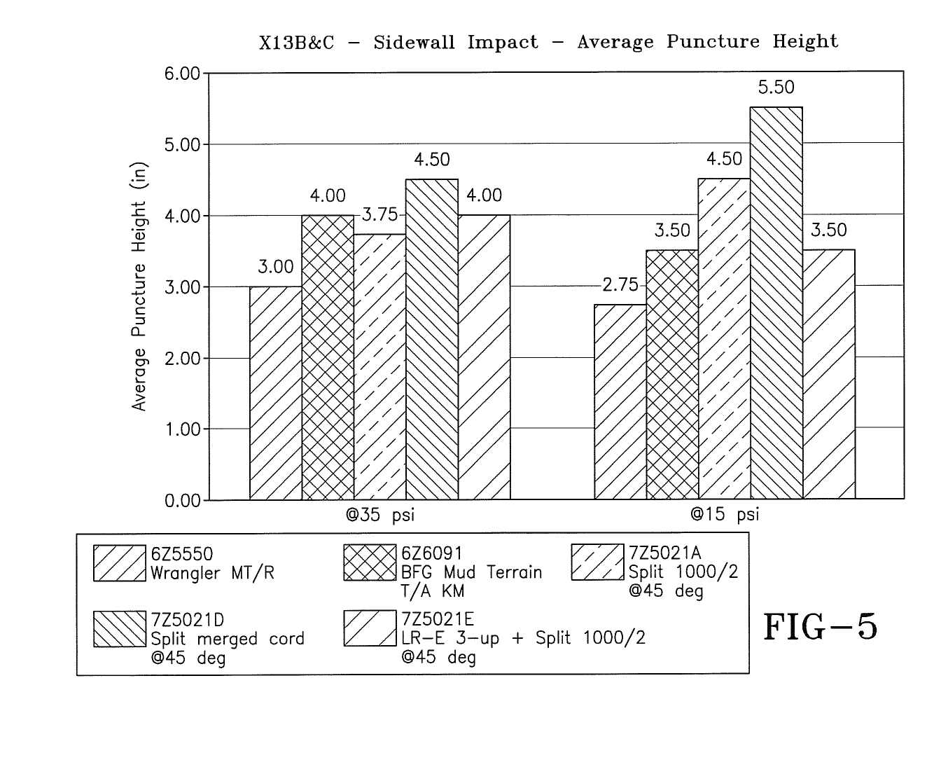

With reference now to FIGS. 2-5, the following test data is provided for the present invention. The following construction information is provided for the tires tested in the sidewall impact test shown in FIG. 2:

1. 6Z5550—Wrangler MT/R (maximum traction/reinforced)—K171H, (2) 1500/2+(1) 1000/2 at 85°

2. 6Z6091—BF Goodrich® Mud Terrain T/A KM

3. Three-ply 7Z5021A—“E” mold—K171H, (2) 2000/2+split 1000/2 at 45° (one embodiment of the present invention)

4. 7Z5021D—“E” mold—K171H, (2) 2000/3+split Merged Cord 28 EPI at 45° (another embodiment of the present invention)

5. 7Z5021E—“E” mold—K171H, (2) 1500/2+(1) 1000/2@85°+split 1000/2 at 45° (another embodiment of the present invention). The test conditions were as follows: Rim: 8.5×17; Inflation: 35 psi and 15 psi; Chisel: ½″; Fixture Weight: 126 lbs; RFP Target (Sidewall Impact Resistance, Tier 4): 130% vs BF Goodrich® Mud Terrain T/A KM. The test results are shown in FIG. 2 and show that the present invention, in this example, provides a +57% improvement on sidewall impact.

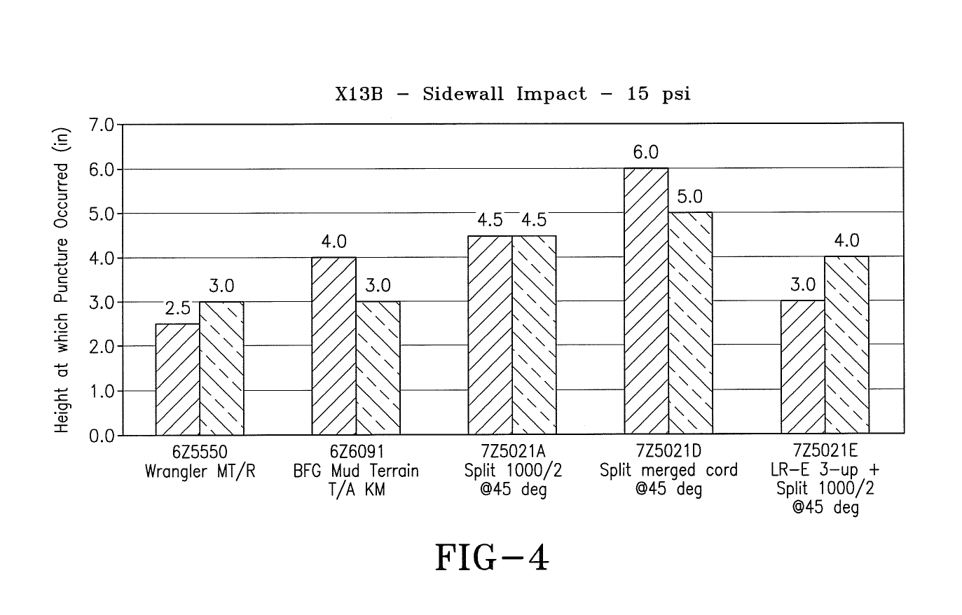

With reference now to FIGS. 2 and 4, the test was run at 15 psi to get a better read of impact resistance at something closer to an off-road inflation. The rank-versus-BFG (B.F. Goodrich®) percentages are based on the two-tire average breaking height. It is shown in this format to try to gauge performance against the target for sidewall impact resistance. Performance of the Wrangler MT/R, 6Z5550, at 35 psi had a puncture height of 3.0″. The 15 psi inflation was expected to allow higher puncture heights, due to the increased flexibility of the carcass, but 6Z5550 was equal to or slightly lower at 15 psi. The average 15 psi puncture height was 2.75″. Performance of the BF Goodrich Mud Terrain T/A KM, 6Z6091 had an average puncture height of 4.0″. The 15 psi inflation was expected to allow higher puncture heights, due to the increased flexibility of the carcass, but 6Z6091 was equal to or slightly lower at 15 psi. The average 15 psi puncture height was 3.5″. 7Z5021A's (one embodiment of the present invention) performance at 35 psi had an average puncture height of 3.75″, but did not meet the BFG's performance of 4.0″, for a ranking of 94%. At 15 psi, 7Z5021A showed improved puncture resistance. Its average puncture height increased to 4.5″, an improvement over the MT/R's 3.0″, as well as the BFG's 3.5″. At 15 psi, 7Z5021A's performance relative to the BFG was 129%.

With continuing reference to FIGS. 2 and 4, the present invention's (7Z5021D) performance at 35 psi was even better than 7Z5021A's, outperforming both the MT/R and the BFG, with an average puncture height of 4.5″. Relative to the BFG, its performance ranking was 113%. At 15 psi, the present invention showed an even larger improvement in puncture resistance. Its average puncture height increased to 5.5″, a significant improvement over the MT/R's 3.0″, as well as the BFG's 3.5″. At 15 psi, its performance relative to the BFG was 157%. 7Z5021E followed the same unusual tread as the MT/Rand BFG, in that its performance decreased slightly at 15 psi versus 35 psi. 7Z5021E significantly outperformed the MT/R at both inflations, but was identical to the BFG, ranking a 100% at both inflations. 7Z5021E outperformed 7Z5021A at 35 psi, but significantly underperformed at 15 psi. This data indicates that both split 1000/2@45° and split Merged Cord 28 EPI@45° should offer improved sidewall toughness over the Wrangler MT/R.

With continuing reference to FIGS. 1-7, the present invention can be arranged in many forms. By way of example, but not intended as a limitation, two of the components of the present invention can be Kevlar®, an aramid available from DuPont and nylon, a polyamide. In several embodiments of the present invention, the following are considered part of the present invention—Kevlar with a nylon core as a core insertion as a carcass single ply, Kevlar and nylon as a merge cord single ply, Kevlar and PET (Polyethylene Terephthalate) as a merge cord single ply, Kevlar with a nylon core as a core insertion single ply with a Kevlar floater, Kevlar and nylon as a merge cord single ply with a Kevlar floater, Kevlar and PET (Polyethylene Terephthalate) as a merge cord single ply with a Kevlar floater, and Kevlar and polyethylene merge in carcass. It is to be understood, however, that any combination of aramid fibers, polyamide fibers, liquid crystalline aromatic polyesters, carbon fibers, fiberglass, and metallic fibers can be used, as long as chosen using sound engineering judgment. It is also to be understood that the angles for the various combinations are between 0° and 180°.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Other than in the operating examples, or where otherwise indicated, all numbers expressing quantities of ingredients, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Having thus described the invention, it is now claimed:

1. A unidirectional fabric for use in an associated vehicle tire, the fabric comprising:
an aramid/polyamide 6, 6 merge cord, wherein the fabric is at an angle to a ply angle in the associated tire.

2. A tire comprising:
a carcass;
a crown portion;
shoulders;
sidewalls;
a bead region;
two beads, the beads being within the bead region; and,
at least one cord, the cord being at least two of the group comprising aramid fibers, polyamide fibers, liquid crystalline aromatic polyesters, carbon fibers, fiberglass, and metallic fibers.

3. The tire of claim 2, wherein the cord is chosen from the group comprising a merge cord, a hybrid, and a core insertion.

4. The tire of claim 3, wherein the cord is chosen from the group comprising unidirectional, bidirectional, multidirectional, film, weave, and knit.

5. The tire of claim 4, wherein the cord is a merge cord.

6. The tire of claim 5, wherein the cord is aramid fibers and polyamide fibers.

7. The tire of claim 4, wherein the cord is a core insertion.

8. The tire of claim 7, wherein the cord is aramid fibers and polyamide fibers.

9. The tire of claim 2, wherein the cord is at an angle with respect to a ply angle, wherein the cord is at an angle of between approximately 135° and approximately 45°.

10. The tire of claim 3, wherein the cord is at an angle with respect to a ply angle, wherein the cord is at an angle of between approximately 135° and approximately 45°.

11. The tire of claim 4, wherein the cord is at an angle with respect to a ply angle, wherein the cord is at an angle of between approximately 135° and approximately 45°.

12. The tire of claim 6, wherein the cord is at an angle with respect to a ply angle, wherein the cord is at an angle of between approximately 135° and approximately 45°.

13. The tire of claim 8, wherein the cord is at an angle with respect to a ply angle, wherein the cord is at an angle of between approximately 135° and approximately 45°.

14. The tire of claim 2, wherein the tire is chosen from the group comprising bias, radial, OTR, aircraft, racing, farm, ATV, MT, LT, and passenger.

15. The tire of claim 9, wherein the cord is at an angle with respect to a ply angle, wherein the cord is at an angle of between approximately 55° and approximately 45°.

16. A tire comprising:
a carcass;
a crown portion;
shoulders;
sidewalls;
a bead region;
two beads, the beads being within the bead region; and, at least one cord, the cord comprising aramid fibers and polyamide fibers, wherein the cord is chosen from the group comprising a merge cord, a hybrid, and a core insertion, wherein the cord is at an angle with respect to a ply angle, wherein the cord is at an angle of between approximately 135° and approximately 45°.

17. The tire of claim 16, wherein the cord is chosen from the group comprising unidirectional, bidirectional, multidirectional, film, weave, and knit.

18. The tire of claim 4, wherein the cord is a hybrid.

19. The tire of claim 18, wherein the cord is aramid fibers and polyamide fibers.

20. The tire of claim 19, wherein the cord is at an angle with respect to a ply angle, wherein the cord is at an angle of between approximately 135° and approximately 45°.
